(19) United States
(12) Patent Application Publication
(10) Pub. No.: US 2020/0197869 A1
(43) Pub. Date: Jun. 25, 2020

(54) Monitoring of membrane modules

(71) Applicant: CMS INTERESTS PTY LTD, Point Piper (AU)

(72) Inventor: Hans Coster, Sydney (AU)

(21) Appl. No.: 16/612,448

(22) PCT Filed: May 11, 2018
(86) PCT No.: PCT/AU2018/050439

§ 371 Date: Nov. 11, 2019

(30) Foreign Application Priority Data
May 11, 2017 (AU) 2017901744

(51) Int. Cl. B01D 63/10; B01D 63/12; B01D 65/10; C02F 1/44; C02F 1/00

(52) U.S. Cl. CPC B01D 63/106; B01D 63/12; B01D 65/10; C02F 1/441; B01D 2313/90; C02F 2209/03; C02F 2303/20; C02F 2209/05; C02F 1/008

(57) ABSTRACT

The extent of fouling of a spiral wound membrane module such as used in water treatment plants can be monitored using one or more sensors disposed between wraps of the membrane. The sensors, including electrodes, can communicate signals to a two-part computing device. A first part is located inside the pressure vessel in which the membrane module is disposed. The first part provides input signals and power to the sensors and receives sensor signals. A second part is located on the outside of the pressure vessel and communicates power to the first part via inductive coupling. The second part wirelessly receives the sensor signals from the first part and processes the signals to determine the extent of fouling of the membrane module.

This invention relates to spiral wound membrane modules, and, in particular, to the in-situ monitoring of such modules to assess their operational performance. The invention extends to both a module capable of being so assessed, and a method of operating a plant in which such modules are installed.

### BACKGROUND

The spiral-wound membrane module has become an industry standard for purification treatment of waste water, and sea water and brackish water desalination. In this configuration large areas of membrane are packaged into a small volume. The industry has standardised diameters and lengths of these membrane modules and there is fierce competition between manufacturers which include Hydranautics, Toray, GE, DOW and others.

Operation of the membrane modules requires careful control of transmembrane pressures (TMP), longitudinal pressure drop (Differential Pressure, DP) along the pressure vessels containing the modules, the flux of water through the membranes, the recovery rate as well as pre-treatment of the feed water to remove particulates and biological material.

### Membrane Fouling

However, despite careful control, the membranes become compromised over time and the performance and salt rejection may decline in a process referred to as membrane fouling.

Membrane fouling can be inorganic, organic, biofouling, or a combination thereof. All fouling processes have their origin in a process referred to as Concentration Polarization that is an inevitable result of removing water through the membrane from the feed. Concentration polarization includes the build-up of salt concentration at the surface which contributes significantly to the osmotic pressure and necessitates increased hydraulic pressures to maintain a given water flux through the membrane.

Whilst the crossflow along the membrane surface is designed to reduce this build-up of material, concentration polarization on the surface of the membrane remains and can, if the membrane flux is maintained at high levels, lead to agglomeration of solid inorganic or organic material on the surface (cake formation) and the attachment and eventual growth of bacteria. Fouled membranes require a cleaning of the modules using aggressive chemicals in a process referred to as Cleaning-in-Place (CIP). This requires the module trains undergoing a CIP to be taken off-line and then rinsed before coming on-line again. Chemical cleaning also causes damage to the membranes that eventually requires their replacement. Typically some 5-15% of modules need replacement per annum either from such damage or from being irreversibly fouled.

### Major Physical Parameters Relevant to the Operation

A number of membrane parameters of relevance to operating performance cannot currently be directly measured. Almost all of the operational parameters measured are averages for a number of modules. In a single pressure vessel there may be anywhere from 1 to 7 modules in series and pressures (TMP and DP), temperature, salt rejection and hydraulic resistance are only obtained as averages for the whole set as the parameters are measured for the overall flow path rather than at the individual module/membrane level.

Furthermore, there is no method available in commercial use that can measure concentration polarization or the degree and nature of membrane fouling. It should be appreciated here that in a multi-module system, the leading module at the feed end will generally be most prone to biofouling, whilst the last, trailing, module at the reject end will be most prone to scaling (accumulation of insoluble calcium salts). Accordingly, different modules in the series can be affected by different forms of fouling.

Generally monitoring in a typical plant will include acquisition and interrogation of some or most of the following parameters:

Feed pressure
Permeate pressure
Reject pressure
Feed flow rate
Permeate flow rate (per m²=Flux)
Reject flow rate
Feed conductivity
Permeate conductivity,
Reject conductivity

### Temperature

pH of feed
pH of permeate

Note that not all of these need to be measured to obtain all of the parameters as some can be deduced from measurements of others (e.g. reject flow=feed flow−permeate flow).

In prior art systems, all of these parameters are measured within the flow streams at beginning and end of the pressure vessel containing the relevant sensors.

### SUMMARY OF THE INVENTION

According to one aspect of the invention there is provided a membrane module including an inlet for receiving feed flow, a permeate outlet through which permeate flow passes, a membrane separating the inlet from the permeate outlet through which permeate passes in use, at least one parameter measuring sensor mounted to the module, and at least one processing device operatively connected to the at least one parameter measuring sensor, wherein the at least one processing device is programmed to obtain signals from the at least one parameter measuring sensor.

Preferably the membrane is a spirally wound membrane, and the sensor or sensors are located between wraps of the membrane. There are preferably a plurality of sensors, sensing different parameters. In one preferred form of the invention there are two pairs of sensors for each module.

Preferably each sensor is in electronic communication with a communication device mounted to said module. The communication device may be formed in two parts, a first part being located within the module, and the second part being located externally of the module, the first and second parts being in wifi, Bluetooth or other wireless communication with each other. Preferably power is provided to the sensors and the first part of the communication device using inductive power transfer. The two parts may be aligned with each other using magnets to provide a means of locating the units relative to each other.

The invention extends to a method of monitoring the extent of fouling of a membrane module in a plant having a bank of such modules, including the steps of locating a membrane module having at least one sensor mounted thereto in said bank, running the plant, interrogating the sensor either continuously or on a regular basis, communicating the results of said interrogation to a computing device, and using the computing device to assess the extent of fouling of the membrane module thus being monitored. Preferably the method extends to mounting a plurality of membrane modules, each having at least one sensor mounted thereto, at different positions in said bank, each of said modules being in communication with said computing device.

According to one aspect of the invention there is provided a method for monitoring an extent of fouling in a water treatment plant having a bank of membrane modules, the method including the steps of locating at least one membrane module having at least one sensor mounted thereto in said bank, running the water plant, interrogating the at least one sensor to obtain a sensor signal, communicating the sensor signal to at least one computing device, and using the computing device to assess the extent of fouling of the at least one membrane module.

According to one aspect of the invention there is provided a water treatment plant including at least one pressure vessel and a plurality of membrane modules disposed within the at least one pressure vessel. One or more of the membrane modules include an inlet for receiving feed flow, a permeate outlet through which permeate flow passes, a membrane separating the inlet from the permeate outlet through which permeate passes in use, at least one parameter measuring sensor mounted to the module, and at least one processing device operatively connected to the at least one parameter measuring sensor, wherein the at least one processing device is programmed to obtain signals from the at least one parameter measuring sensor.

These and further features of the invention will be made apparent from the detailed description which follows here below. In the description reference is made to the accompanying drawings, but the specific features shown in the drawings should not be construed as limiting on the invention.

### BRIEF DESCRIPTION OF THE DRAWINGS

In the description, reference is made to the following drawings:

FIG. 1 shows a perspective view of a membrane module, part cut-away, indicating the placement of sensors relative to the spirally wound membrane;

FIG. 2 shows a simplified cross-sectional end view of a module, showing the placement of the two-part communication device relative to the pressure module which surrounds the spirally wound membrane;

FIG. 3 shows a diagrammatic representation of the two-part communication device, and the components thereof;

FIG. 4 shows a circuit sensor, suitable for use in a membrane module, with connecting wires for connecting to a communication device;

FIG. 5 shows a preferred location of the electrodes on the two sides of a membrane;

FIG. 6 shows an anti-telescoping end cap (Anti Telescoping Device, ATD) in which the communication device will be mounted in use; and

FIG. 7 shows a circuit sensor similar to FIG. 4 depicting an insulating mask over the connecting leads.

### DETAILED DESCRIPTION OF THE PREFERRED EMBODIMENTS

A typical desalination module 10 as may be used in a reverse osmosis plant is depicted in the drawings. A desalination module of this type includes a central perforated permeate tube 12 around which a membrane assembly 14 is spirally wound. The membrane assembly 14 comprises a series of sheets designed to permit permeate to pass through the module from the inlet side 16 thereof to the outlet 18. Two adjacent membrane sheets are separated from each other on the permeate side by a spacer fabric that allows the permeate to move spirally inwards to the central permeate tube 12. The membrane assembly 14 is encased in a fiberglass jacket to form a complete module 27.

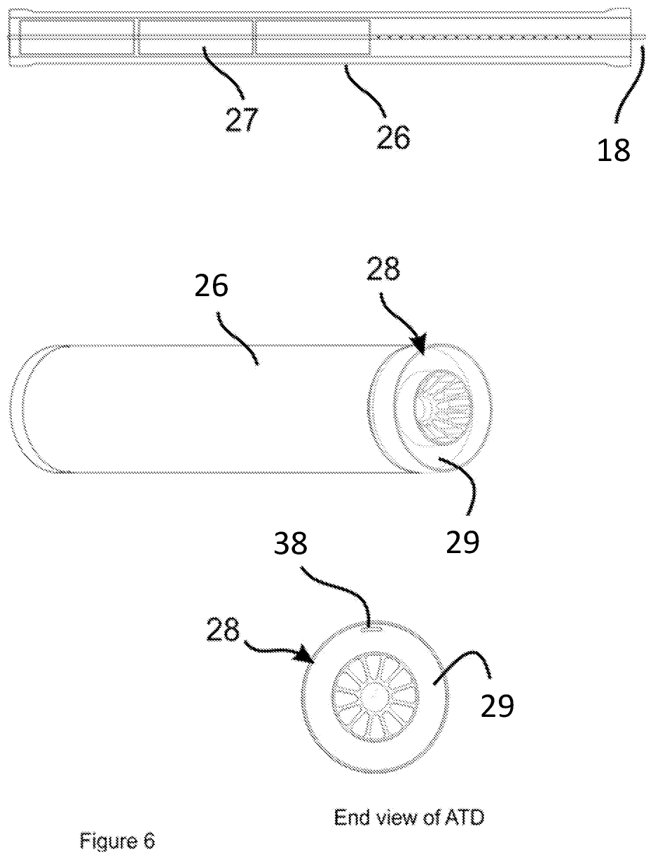

Generally, a number of such modules will be connected end to end in series, with the outlet 18 of the first module being connected to the permeate tube of the second module, and concentrate fluid passing into the inlet side of the second module. The membranes may be, for example, thin (200 micron) sheets of semi-porous polysulphone coated with a very thin (1 micron) and more dense active layer. This active layer faces the feed side. There are many different membrane compositions in use and details of their constitution is generally held in commercial confidence. The membrane assembly 14 may comprise 20 or more membrane sheets spaced apart by a permeate spacer sheet 22, and a feedwater and concentrate spacer sheet 21. The permeate sheet 22 is designed to direct permeate flow inwards, towards the permeate tube 12, and the feedwater spacer sheet 21 directs reject feedwater (containing a higher percentage of salt and other materials rejected by the membrane) along the length of the module and spirally inwards towards the next module for further treatment in that module. The membrane assembly will be housed within a pressure vessel 26 fitted with anti-telescoping end caps (ATDs) 28 best seen in FIG. 6. The pressure vessel 26, often manufactured from glass reinforced resin, is designed to withstand an internal pressure which can be about 6 to 8 Bar in waste water treatment plants to upwards of about 60 to 80 Bar in high salinity desalination plants. The structure and form of desalination modules 10 are well known in the art, and need not be discussed in more detail herein.

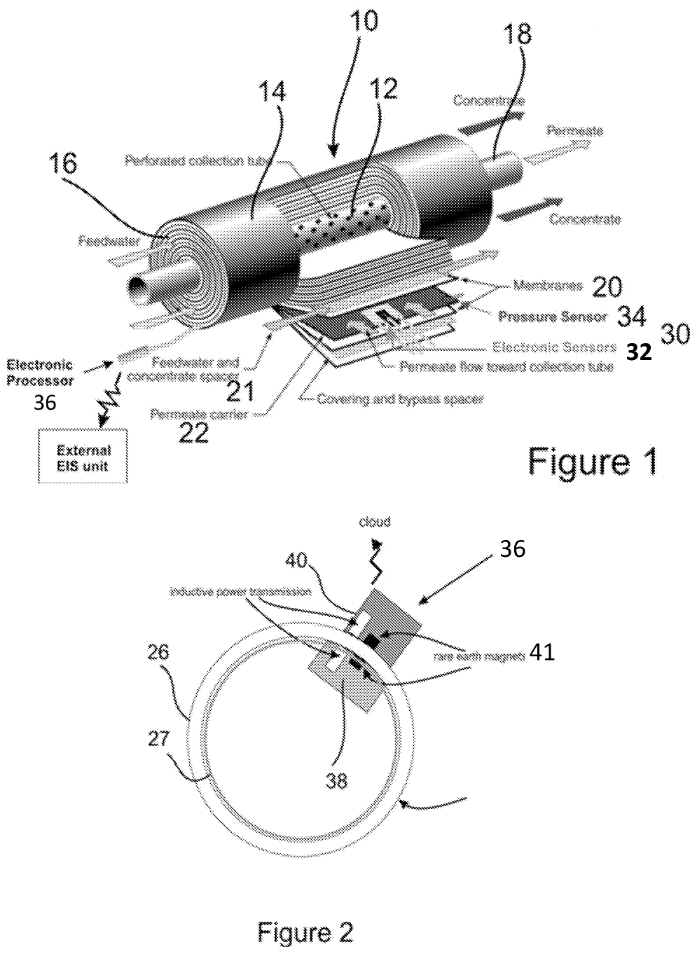

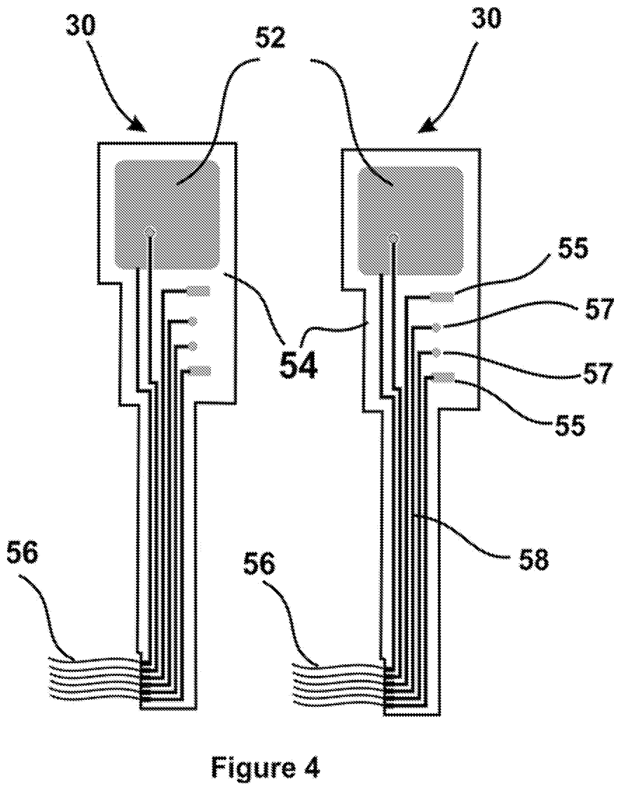

As stated above, it is a problem with prior art desalination modules to accurately measure various parameters of the flow to enable an accurate determination of the condition of the modules. To help combat this problem, a sensor arrangement may be provided within a module. As shown in FIG. 1, sensors 30 are mounted between sheets of the membrane assembly 14. In the example shown in FIG. 1, the sensors 30 comprise an electronic sensor 32 and a pressure sensor 34. The sensors, an example of which is shown in FIG. 4, are electrically connected to an electronic sensor processing and communication device 36 mounted to an end cap (ATD) 28 of the module. The sensor and communication device 36 is discussed in more detail below.

A number of sensor technologies can be adapted to fit into a spiral-wound membrane module to provide in-situ on-line monitoring of conditions relevant to the condition and/or optimum operation parameters for such modules. The purpose of such sensors is to monitor membrane and fluid conditions within the spirally wound membrane assembly.

This allows these modules to be monitored individually to indicate requirements to alter operating parameters, assess when membrane cleaning and/or replacement is required, and so forth. The communication device includes built-in electronics that communicate the conditions assessed by the sensors to an external computer device.

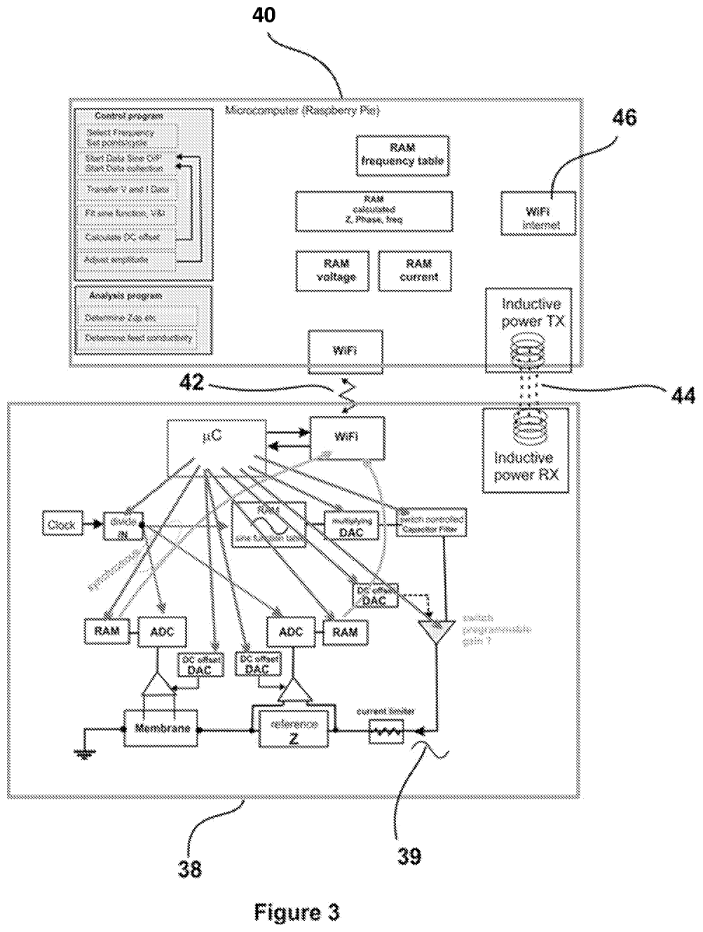

In one embodiment, the sensor processing and communication device 36 includes two parts, an internal part 38, that is, located within the pressure vessel, and an external part 40, that is located outside of the pressure vessel. The two parts 38 and 40 communicate with each other via WiFi, Bluetooth, Near-field communications protocols or other wireless methods through the wall of the pressure vessel, thus not compromising the integrity of the pressure vessel. Specialised electronics have been developed that allow electrical signals and responses to be measured. FIGS. 3 and 4 depict a preferred form of communication protocol, shown in diagrammatic form. As indicated, the external part 40 communicates with the internal part via WiFi, Bluetooth or other wireless methods, as indicated at numeral 42. Power is provided to the internal part via inductive power transmission as indicated at numeral 44. The external part 40 is able to communicate with an external computing device, such as a lap top computer, either via WiFi, Bluetooth or other wireless methods, as indicated at numeral 46, or via a wire connection. The connection to the external computing device could also be via a cloud connection to enable the plant to be monitored from a remote location.

The external part 40 may incorporate a small microcomputer such as the Raspberry Pi machine. These devices are commercially available and include a processor, memory (both storage memory and random access for memory for program execution), communications modules, communication ports (e.g. USB) etc. within a housing. The machine 40 may be connected to an external power supply such as a mains terminal or battery supply. The Raspberry Pi machine or other similar small computing units may be readily programmed and modified for use in the present embodiments.

An embodiment of a sensor 30 is shown in FIG. 4 of the drawings. The sensor 30 is shown having sensor technology 52 fabricated onto a flexible and electrically insulating, sub-strata 54, and provided with insulated wires 56 for electrically connecting the sensor to the internal part 38 of the communication device 36.

As mentioned, the communication device, as shown in FIG. 2 is preferably mounted within or to the anti-telescoping end cap ATD 28 shown in more detail in FIG. 6 of the drawings. The end cap ATD 28 is provided with internal cavities 29 into which the internal part 38 will be housed. Clearly, the shape and positioning of the cavities 29 will depend on the shape and size of the internal part 38. As mentioned above, the external part 40 will be juxta-positioned adjacent to the internal part, so that the two parts can be in WiFi, Bluetooth or other wireless communication with each other.

Power required for the internal electronics is supplied by a rechargeable battery which is recharged by power transmitted to the unit by induction from a coil located outside the pressure vessel. This external unit also contains further electronics and software to extract various parameters from the data and transmits that via WiFi either directly to a cloud-based data base or local computer.

For operation, the internal electronics unit and external device should be closely juxta positioned. To facilitate this the internal unit is fitted with small rare-earth magnets 41 and the external unit with Hall-effect, magnets or other devices to detect the internal magnets to locate the internal unit relative to the external unit. LEDs will indicate when the unit is correctly positioned and data acquisition connections are established. Alternatively, the optimum location can be determined by monitoring the induction power transfer and adjusting the position for maximum power transfer.

The following types of sensors could be fitted within the membrane assembly.

Electrical impedance Spectroscopy (EIS)

This allows direct monitoring of the membrane surface to detect fouling, including inorganic cake formation and biofouling and crucially, the threshold where these are beginning to occur, before these impacts on the TMP, DP or salt rejection. EIS technology is described more fully in published patent application no WO2016171629 (A1) (Coster et al), the contents of which are herein incorporated by reference. In order to make impedance measurements, small alternating electric currents are passed through the membrane or a patch of the membrane (referred to hereinafter as the stimulus) and the electrical potential developed across the membrane (referred to hereinafter as the response) as well as the phase difference between the stimulus and response signals are measured. This may be achieved by electrodes that are fitted inside the membrane module.

In one preferred embodiment of the present invention, the spiral wound membrane module is fitted with electrodes located adjacent to the spacer fabric on the two opposite sides of the membrane. In this configuration the electrodes are separated from the membrane by the feed spacer fabric on one side and the permeate spacer fabric on the other side. One suitable “four terminal method” of electrical impedance measurements is taught in International Patent Application No PCT/AU2007/000830 by Coster and Chilcott entitled “A System for complex impedance measurement”, the contents of which are incorporated herein by reference. In this four terminal method, the stimulus alternating electrical current 39 is passed through the membrane using two electrodes on either side of the membrane and the voltage response developed across the membrane are measured using two separate electrodes on either side of the membrane. One advantage of using such a four-terminal method is that fouling of the electrodes themselves will not affect the measurement of the membrane impedance to any significant degree. Another advantage is that use of four-terminal measurement eliminates the impedance of the electrode-solution interface from the total impedance measured.

In another alternative embodiment, two electrodes only are embedded in the spacer fabric, one on each side of the membrane. The impedance measurements can then be made using the same pair of electrodes to inject the stimulus signal and to measure the response. Generally speaking, this method would have the relative disadvantage of potentially being more subject to interference from fouling and other factors, but it may be simpler and cheaper to manufacture the device.

### Feed and Permeate Conductivities

Using suitable electrodes the electrical conductivities in the narrow feed space and permeate space between the membranes can be measured directly for that module. From this the salt rejection can be obtained. Limitations of space require the electrodes used to make such conductivity measurements to be small, and therefore a “four terminal” method of making the conductivity measurements, as described hereinabove, is preferred. However, other methods including a two terminal method may be utilized. A four terminal method requires two electrodes 55 to pass a small alternating stimulus current of suitable frequency from one electrode to the other and the two separate electrodes 57 located between the two stimulus current electrodes to measure the voltage response in the fluid. This allows the conductivity of the solution to be determined without complicating factors related to the impedance of the electrode-solution interface.

Measurement of the conductivities of the feed solution and permeate allow the degree of salt rejection by the membrane to be determined. The salt rejection tends to decrease as fouling of the membrane proceeds and this provides a further technique for monitoring the performance of the membrane module.

### Temperature

Metal resistance sensors printed onto thin polymer films that form the substrates for the other sensors will allow direct measurement of the temperature of both the feed and permeate fluid in the narrow channels between the membranes. Alternatively, small thermocouples inserted into the permeate and feed spacer fabric sheets may be employed. Removal of salt from the feed solution during reverse osmosis causes an increase in temperature and the temperature difference provides a direct measure of the local thermodynamic work done.

### Differential Pressure

The pressure drop across the membrane and the pressure drop across the length of a single spiral wound module provides information on the degree of fouling of the membrane.

Pressure sensors incorporated in the polymer end plates (also referred to as anti-telescoping-devices, ATD) allow the Differential Pressure along a single module to be measured directly. This is useful to determine the accumulation of material in the narrow feed spacer between membrane leaves.

### Other Possible Sensors

These could include thermal anemometry flow sensing to monitor feed crossflow etc., optical sensors using miniature LEDs to measure material properties in cake layers.

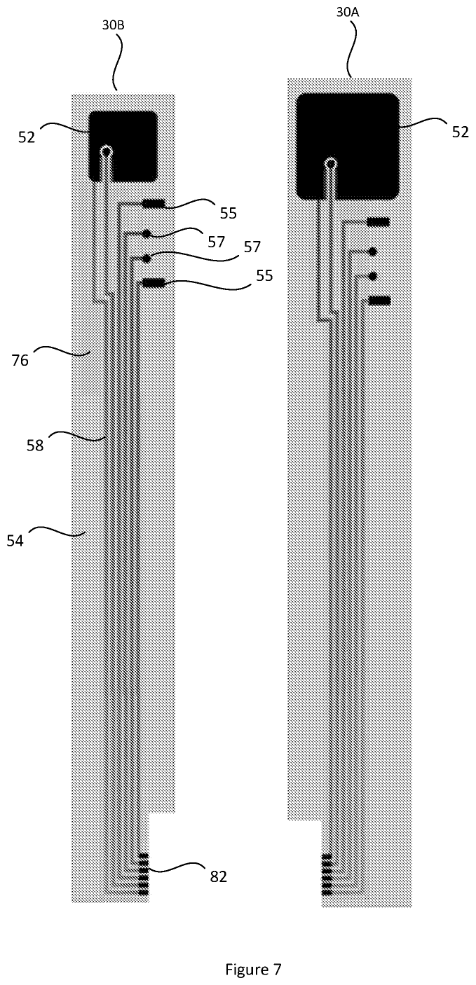

While specific forms of sensor are described herein, the person skilled in the art will recognise that different sensors may also be utilized to monitor condition of the membrane module. In particular, while different sensor types are discussed individually, it will be appreciated that an electrode may include multiple sensor types, as shown in FIGS. 4 and 7 in particular, so that multiple parameters may be measured from a single electrode.

### Multi-Point Monitoring

In one embodiment, sets of electrodes and sensors are located at four separated points on a membrane in a spiral wound module. These provide for monitoring of variations from point-to-point due to different positions in the feed and permeate path as well as local variations in membrane properties.

The placement of the electrodes within the module can be designed to enable monitoring of the various parts of the membranes within the module such as the feed side, discharge end and so on, or the module may be fitted with multiple sets of electrodes to monitor the membrane at a variety of locations within the module.

Conductivity Measurements are done using a 4-terminal electrical measurement technique to avoid large electrode-solution interface impedances. In lab-scale instruments the measurements are generally done using a 2 terminal measurement technique and the large interface impedances are minimised using platinum electrodes coated with “platinum black” which have a very large surface area. This is not an option for the membrane module where small, uncoated, electrodes are required.

As the electrodes are going to be constantly exposed to a high salinity solution, they need to chemically inert to:
Reactions with the chloride ions;
Reactions to citric acid (at pH˜2) used to clean the membranes;
Sodium Hydroxide (pH 11) used in the chemical cleaning of the membranes;
Low concentrations of anti scalant chemical and biocides.

As small electrical currents are injected via some of the electrodes, depending on the sensor type, it may be a requirement that the electrodes are also inert against electro-chemical reactions at the electrode-solution interface. In that regard, silver electrodes are known to undergo such reactions;

Ag+Cl⁻ [symbol] AgCl+e⁻

However, with AC currents, as used in EIS, the reaction would reverse each half-cycle of the AC current and therefore silver electrodes may be appropriate for EIS and similar type sensors.

### Mounting and Insulation of the Electrodes

For purposes of inserting the electrodes between layers of the membranes in the modules, the electrodes can be attached to a thin film of a suitable polymer. This polymer film also provides insulation to the backside of the electrodes leaving only the front surface exposed to the solution.

The backing film should be:
Thin;
Flexible;
Electrically insulating;
Chemically stable in citric acid (pH ˜2) and sodium hydroxide (pH 12) (polyamide, for example, would NOT be suitable); and
Adhere well to polyurethane adhesives.

### Positioning the Electrode Sensors

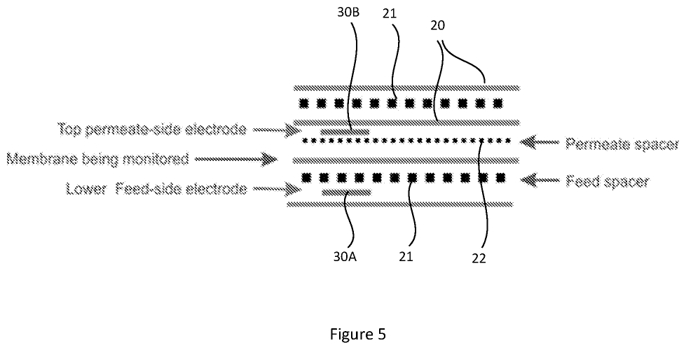

FIG. 5 is a cross section showing the location of the electrode/sensors 30 within the layers of the membrane module. Each electrode set shown in FIG. 5 may contain 4 or 6 or more separate electrodes but are here shown diagrammatically as one. The membranes, spacer fabric and electrodes are shown separated for clarity. In an actual model the sheets and spacer fabric are pushed tightly together. The electrodes are positioned with one half 30A of a pair on the feed side of the spacer fabric and membrane and the other 30B on the permeate side of the membrane and permeate spacer fabric. The electrodes are kept away from the membrane being monitored by their location on the other side of the intervening feed spacer or permeate spacer fabric. This ensures that the flux through the membrane patch being monitored is not impaired.

### Dimensional Requirements

As the electrodes are placed in the feed and permeate channels of the membrane modules, the overall thickness of the electrodes and the backing polymer film should be kept as low as possible, for example approximately 50 microns.

### Electrode/Sensor Patterns

FIG. 7 shows a sample pattern of the electrodes. The electrodes include a feed side electrode 30A and a permeate side electrode 30B. Each electrode includes sensors 52 and EIS electrodes 55, 57 of metal or other conducting material that are exposed to the solution on a polymer backing film 54 to which the conducting elements are bonded. The electrodes 30A, 30B include conducting leads 58 that connect from the sensors/EIS electrodes to terminals 80 which can be subsequently connected to the processing device 36 as described above. An insulating mask 76 covers the leads 58, leaving the sensor surfaces 52, EIS electrodes 55, 57 and terminals 80 exposed.

### Electrical Connections

Electrical connections to the electrode terminals 80 are via very thin, flat, cable connectors that can be placed along the outer surface of the cylindrical membrane module where they terminate at the electronic device built into the proprietary end cap (anti telescoping device).

For each of the sensor pairs (poles) there may be up to 12 connections to be made.

### Selection of Materials

### Gold

Very good stability, low electrical resistance, mechanically soft, easy to make solder connections. Electrodes are “blocking” electrodes; no chemical reactions occur at the electrode solution interface. The electrode-solution interface impedance is high and frequency dependent.

### Stainless Steel SS 314 or Better

Cheap, relatively stable but not as good as gold. Some electrically driven oxidation reactions may occur at the metal-solution interface, especially at AC frequencies below 100 Hz, which is a region of special interest. Reactions may be minimised by maintaining the electrical current very small. Stainless steel is mechanically hard. It requires nickel plating at the connection points to make solder connections.

### Silver Electrodes

Silver is an excellent conductor and thin sheets of silver are readily available. Silver in contact with a saline solution rapidly develops a coating of AgCl. The latter is very insoluble and acts to pacify the surface. Nevertheless, such an electrode will be less chemically stable than gold or stainless steel.

An important advantage would be that the metal solution interface impedance for an Ag/AgCl electrode is very much smaller than that of gold or stainless steel because it is a “half-blocking” electrode rather than a “blocking” electrode.

### Hybrid Metal Electrodes

Gold plated copper electrodes. The copper underlay can be manufactured using photo-resist printed circuit board technology. This can be done on thin (50 micron) flexible circuit boards.

The copper can be gold plated to produce a relatively inert electrode.

Pin holes in the gold coating may allow access of electrolyte to the copper. This sets up a galvanic reaction that dissolves the copper leaving the gold without attachment. The process, once started, will gradually remove all the copper and gold.

### Silver and Carbon/Graphite Printed Electrodes

The electrode patterns, in principle, can be printed onto a polymer film using electrically conductive ink. The electrical resistance of such electrodes is much higher than that of gold or other metal electrodes. The silver based conducting inks have a lower specific resistance than carbon based conducting inks. By retracing several layers of the pattern, the resistance may be low enough to be workable.

Silver conducting inks may react with the chloride ions in solution to form a film of AgCl on the silver particles exposed to the solution.

### Plant Monitoring

Modules incorporating sensors as herein described can be deployed in a water treatment plant so that the state of the membrane modules can be monitored. Signals obtained from the embedded sensors can indicate the extent of fouling of a membrane module in a plant having a bank of such modules. With the plant in operation, the sensors can be interrogated either continuously, on a regular basis, or in response to an external trigger. The sensor signals can be processed at the processing device 36 to determine the state of the sensor module. For example, the processing device may store comparative data that may be used to compare the current state of a module with a known state, such as a brand new or clean module, fouled module, etc. Alternatively or in addition, the processing device may store and execute algorithms that calculate from the available parameter values (e.g. pressure, temperature, conductivity) whether or not a maintenance procedure should be performed.

The results of the analysis can be used to modify one or more of a module replacement cycle, a module refurbishment cycle and a module cleaning cycle or may indicate other actions to be undertaken at the plant.

In an alternative embodiment, the processing and communications device 36 may simply receive and amalgamate the sensor signals and communicate the sensor signals to an additional external computing device (not shown) for further processing.

In one embodiment, the processing and communications device 36 may be programmed to execute sensing and analysis routines using the embedded electrodes. In one particular embodiment, the processing device 36 may execute an EIS analysis routine in which waveforms are provided to EIS terminals of the electrode and a frequency dependent response is obtained. The frequency dependent response can be analysed within the processing device 36 or communicated to an additional monitoring device (not shown). The frequency dependent response may be compared to a baseline or similar to determine the level of fouling, salt contamination, etc. of the membrane being monitored. The frequency dependent response may be used to calculate a conductivity value that indicates the extent of fouling. The analysis, which may also be coupled with additional sensor signals such as temperature and pressure, may be used to determine one or more maintenance operations to be performed on the plant.

### Multi-Module Monitoring

Because the operational conditions at the feed end in a module train are very different from the reject end, sensor modules could be fitted at these two locations to monitor the condition at opposite ends of a given train. The feed end is more prone to biofouling, whilst the reject end is more prone to scaling. In some circumstances these modules, if the monitoring indicated it, could be removed and replaced without requiring the remainder of the modules in the pressure vessel to be subjected to cleaning in place (CIP). The removed modules could then be cleaned separately for later re-use, significantly decreasing the cost of cleaning. This would also reduce down-time and reduced chemical requirements for the CIPs.

All modules in a pressure vessel could be fitted with sensors and it would be possible to pin-point problem modules requiring cleaning or replacement, without having to change all modules. Sensors of multiple modules may be connected to a single processing device 36, or to multiple processing devices 36.

An intention of monitoring individual modules is to provide a direct way of optimising the operational parameters of the plant to reduce power, reduce CIPs, increase module lifetimes and decrease down times. In new plants this could lead to substantial saving in cost of plant since optimal operational and accurate monitoring would mean there would be a reduced capacity requirement.

By measuring electrical conductivity within the narrow space (containing a fabric spacer material) between the membrane, directly in the feed and permeate channel, a more accurate determination of the degree of salt rejection in a fluid can be obtained. The electrodes and sensors required for this have special attributes to enable them to be placed within the narrow feed channels without interfering with the flow patterns of the membranes being measured.

Variations to the embodiment may be made without departing from the ambit of the invention. Of course, for different plant configurations there will be different modules. One advantage of the present invention is that fitting the in-situ monitoring apparatus does not mean that the plant needs to be modified in any significant way. An existing module can simply be swapped out, and replaced with a monitoring module, and the plant will then be operational again, in a matter of minutes.

What is claimed is:

1. A membrane module including an inlet for receiving feed flow, a permeate outlet through which permeate flow passes, a membrane separating the inlet from the permeate outlet through which permeate passes in use, at least one parameter measuring sensor mounted to the module, and at least one processing device operatively connected to the at least one parameter measuring sensor, wherein the at least one processing device is programmed to obtain signals from the at least one parameter measuring sensor.

2. (canceled)

3. (canceled)

4. The membrane module of claim 1 wherein the at least one parameter measuring sensor includes at least one electrode pair including a first electrode disposed on a first side of the membrane and a second electrode disposed on a second side of the membrane.

5. (canceled)

6. The membrane module of claim 1 wherein the at least one parameter measuring sensor includes at least one electrode set for performing electrical impedance spectroscopy.

7. The membrane module of claim 1 wherein the membrane module is configured to be disposed within a pressure vessel, wherein the at least one processing device includes:
a first part that is configured to be disposed within the pressure vessel and is operatively connected to the at least one parameter measuring sensor; and
a second part that is configured to be disposed outside of the pressure vessel and communicate with the first part through the pressure vessel.

8. The membrane module of claim 7 wherein the first part is inductively coupled to the second part and is configured to receive power from the second part via the inductive coupling.

9. The membrane module of claim 7 wherein the first part is programmed to wirelessly communicate a sensor signal received from the at least one parameter measuring sensor to the second part.

10. The membrane module of claim 9 wherein the second part is programmed to process the sensor signal to determine a fouling state of the membrane module.

11. The membrane module of claim 7 wherein the first part is programmed to apply one or more input signals to one or more electrodes of the at least one parameter measuring sensor and to receive response signals from one or more electrodes of the at least one parameter measuring sensor.

12. The membrane module of claim 1 including a plurality of parameter measuring sensors disposed at separate locations on the membrane of the membrane module.

13. A method for monitoring an extent of fouling in a water treatment plant having a bank of membrane modules, the method including the steps of:
locating at least one membrane module having at least one sensor mounted thereto in said bank;
running the water plant;
interrogating the at least one sensor to obtain a sensor signal;
communicating the sensor signal to at least one computing device; and
using the computing device to assess the extent of fouling of the at least one membrane module.

14. The method of claim 13 including:
mounting a plurality of the membrane modules having at least one sensor mounted thereto, at different positions in said bank, each of the membrane modules being in communication with the at least one computing device; and
individually monitoring the extent of fouling of the plurality of membrane modules.

15. The method of claim 13 wherein the membrane module includes a spirally wound membrane wound around a perforated collection tube, the method including locating at least one sensor between wraps of the spirally wound membrane.

16. The method of claim 13 including locating the bank of membrane modules within a pressure vessel, locating a first part of the computing device within the pressure vessel, locating a second part of the computing device outside of the pressure in wireless communication with the first part; communicating signals received from the at least one sensor by the first part to the second part.

17. The method of claim 16 including powering the first part by inductive coupling from the second part.

18. The method of claim 16 including performing electrical impedance spectroscopy using input signals generated from the first part and applied to one or more electrode sets disposed within the at least one membrane module.

19. The method of claim 13 including locating a plurality of sensors at a plurality of separate points within the at least one membrane module and monitoring the plurality of points of the at least one membrane module.

20. A water treatment plant including:
at least one pressure vessel;
a plurality of membrane modules disposed within the at least one pressure vessel, one or more of the membrane modules including:
an inlet for receiving feed flow, a permeate outlet through which permeate flow passes, a membrane separating the inlet from the permeate outlet through which permeate passes in use, at least one parameter measuring sensor mounted to the module, and at least one processing device operatively connected to the at least one parameter measuring sensor, wherein the at least one processing device is programmed to obtain signals from the at least one parameter measuring sensor.

21. The water treatment plant of claim 20 wherein the at least one processing device is programmed to obtain signals from a plurality of parameter measuring sensors of a plurality of membrane modules.

22. The water treatment plant of claim 20 wherein the at least one processing device includes:
a first part disposed within the pressure vessel and operatively connected to the at least one parameter measuring sensor; and
a second part disposed outside of the pressure vessel and in communication with the first part through the pressure vessel.

23. The water treatment plant of claim 22 wherein the first part is inductively coupled to the second part and is configured to receive power from the second part via the inductive coupling and wherein the first part is programmed to wirelessly communicate at least one sensor signal received from the at least one parameter measuring sensor to the second part, wherein the second part is programmed to process the at least one sensor signal to determine an extent of fouling of at least one of the membrane modules.

24. The water treatment plant of claim 23 wherein the first part includes a magnet for locating the first part in alignment with the second part.

25. The water treatment plant of claim 20 wherein the at least one parameter measuring sensor includes at least one electrode disposed between wraps of a spirally would membrane of the respective membrane module.
